(19) United States
(12) Patent Application Publication
(10) Pub. No.: US 2025/0229477 A1
(43) Pub. Date: Jul. 17, 2025

(54) APPARATUS AND METHOD FOR THE PRODUCTION OF PLASTIC MATERIAL PREFORMS WITH CONTROL OF THE PRODUCTION UNITS DEPENDING ON INSPECTION RESULTS

(71) Applicant: KRONES AG, Neutraubling (DE)

(72) Inventors: Stefan SCHOBER, Tegernheim (DE); Dieter WUENSCHE, Straubing (DE); Florian GELTINGER, Donaustauf (DE); Anton NIEDERMEIER, Offenstetten (DE); Andreas ROTH, Erlangen (DE)

(21) Appl. No.: 19/022,049

(22) Filed: Jan. 15, 2025

(30) Foreign Application Priority Data
Jan. 15, 2024 (DE) 10 2024 101 049.5

(51) Int. Cl. B29C 49/78; B29C 49/06

(52) U.S. Cl. CPC B29C 49/78; B29C 49/06; B29C 2049/7876

(57) ABSTRACT

An apparatus for producing plastics material preforms, has a production device having a plurality of production units for producing plastics material preforms, a transport device which is configured for transporting the plastics material preforms produced by the production device, a control device for controlling the production device, and a first inspection device which is configured for inspecting at least one area of the plastics material preforms produced by the production device. The inspection device is configured for outputting at least one value which is characteristic of a physical property of the plastics material preforms. The apparatus has an assignment device which is configured for assigning to each inspected plastics material preform the production unit which has produced this plastics material preform and wherein the control device is configured for controlling the production device and in particular the production units as a function of this value.

### BACKGROUND OF THE INVENTION

The present invention relates to an apparatus and a method for producing plastics material containers and, in particular, plastics material bottles. Numerous apparatuses and methods of this kind are known from the prior art.

Typically, so-called plastics material preforms are heated and formed and in particular expanded into the plastics material containers by a forming device such as a blow molding machine, in particular a stretch blow molding machine. In recent times, apparatuses and methods have also become known in which the plastics material preforms themselves are produced, for example by injection molding machines, and then formed.

This can offer the advantage that less heating of the plastics material preforms is required in order to expand them, because they come out of the production process already heated. However, apparatuses and methods of this kind require more precise monitoring of the plastics material preforms, so that fewer errors and less waste occur during the production of the plastics material containers.

DE 10 2009 011 269 B3 discloses a method and an apparatus for rejecting retained samples from a production process of matching molded parts.

DE 600 28 756 T2 describes a method and an apparatus for handling ejected injection molded parts.

DE 10 2018 102 299 A1 describes a method and an arrangement for controlling at least one process parameter of an injection molding machine.

The present invention is based on the object of improving the automation and/or error processing of systems of this kind.

### SUMMARY OF THE INVENTION

An apparatus according to the invention for producing plastics material preforms has a production device which is suitable and intended for producing plastics material preforms, wherein the production device has a plurality of production units for producing the plastics material preforms and furthermore a transport device is provided which is suitable and intended for transporting the plastics material preforms produced by the production device, wherein the apparatus (1) has a control device for controlling the production device and/or the production units.

According to the invention, the apparatus has a first inspection device which is suitable and intended for inspecting at least one area of the plastics material preforms produced by the production device, wherein the inspection device is suitable and intended for outputting at least one value which is characteristic of a physical property of the plastics material preforms, wherein the apparatus has an assignment device which is suitable for assigning to each inspected plastics material preform the production unit which has produced this plastics material preform and wherein the control device is suitable and intended for controlling the production device and in particular the production units as a function of this value.

In a preferred embodiment, the inspection device is suitable and intended to output several values which are characteristic of the inspected plastics material preforms, in particular the quality of the mouth head. Preferably, values for complete shaping such as in particular but not exclusively (ShortShot), ovality, freedom from defects of the mouth sealing surface, freedom from defects of the support ring are output.

Preferably, the apparatus has a removal device which transports the plastics material preforms away from the production device. This removal device can form part of the transport device mentioned above.

Preferably, the removal device has a carrier which is suitable and intended for the receptacle of a plurality of plastics material preforms, wherein these are preferably in a predetermined and constant position relative to one another from the received plastics material preform.

In a preferred embodiment, the production units each have cavities for forming the plastics material preforms and/or mold tools for forming the plastics material preforms.

In a further preferred embodiment, at least one parameter of the production device and/or the production units is controllable, wherein this parameter is selected from a group of parameters which includes valve gate times, injection delay/timing, injection profiles, pressure profile, holding pressure (in particular pressure profile and time), cooling time, screw speed, back pressure of the melt, position and pressure of the closing unit (e.g. injection compression molding) as well as temperatures of cavity and/or a nozzle (possibly individually per nozzle), hot runner in individual zones, heating zones of the plasticizing.

Preferably, this at least one parameter can be controlled taking into account the value detected by the inspection device.

In a further advantageous embodiment, the control device for controlling the production device is a control device which is suitable and intended for controlling the production device and in particular the production units as a function of this at least one value.

Preferably, this provides a (particularly closed) control loop that enables the production units and, in particular, the above parameters to be controlled as a function of an inspection result from the first inspection device mentioned above (and preferably also as a function of an inspection result from the second inspection device described in more detail below).

In a further advantageous embodiment, the apparatus has a cooling device for cooling the plastics material preforms produced by the production units.

Preferably, the first inspection device is arranged between the production device and the cooling device. However, it would also be possible for the first inspection device to be arranged downstream of the cooling device.

In a further advantageous embodiment, the first inspection device has an image recording device which is suitable and intended for recording a spatially resolved image of a plurality of plastics material preforms. Particularly preferably, the first inspection device is a thermal imaging camera and/or the first inspection device is suitable and intended to capture spatially resolved thermal images of the plastics material preforms or at least one area of the plastics material preforms.

Preferably, a wavelength range that can be detected by the thermal imaging camera is between 300 nm and 15,000 nm and preferably between 5,000 nm and 12,000 nm and particularly preferably between 8,000 nm and 12,000 nm.

Preferably, the apparatus has an evaluation device which is suitable and intended for evaluating the images recorded by the inspection device. Preferably, this evaluation device is suitable and intended for evaluating the image recorded by the image recording device with regard to each of the plastics material preforms captured in the image.

In a further advantageous embodiment, the apparatus has a second inspection device which is suitable and intended for inspecting the plastics material preforms and which is preferably arranged between the above-mentioned cooling device and at least one subsequent device such as about a forming device (130).

Preferably, at least one inspection device and preferably both inspection devices are suitable and intended for detecting and/or outputting at least one and preferably a plurality of values which are characteristic of physical properties of the plastics material preforms.

Preferably, the above-mentioned assignment device is suitable and intended for assigning to each plastics material preform inspected by the second inspection device the production unit which has produced this plastics material preform.

Preferably, the control device is suitable and intended to control the production device and in particular the production units as a function of this value (detected by the second inspection device).

Preferably, an inspection device is understood to be an inspection device which is suitable and intended for inspecting the plastics material preforms after they have been produced and, in particular, immediately after they have been produced but before they have been cooled (but possibly also after they have been cooled). For this purpose, a carrier can be provided, which supports a plurality of plastics material preforms (immediately) after their production, so that the image recording device can record an image of the plastics material preforms held or supported by the carrier (in particular of at least one region of these plastics material preforms).

Preferably, the first inspection device is integrated into the production device.

In a further preferred embodiment, the inspection device is configured in such a way that it has or makes possible a mouth inspection of the plastics material preforms directly at a removal device, which removes the produced plastics material preforms from the production device.

In a further preferred embodiment, the apparatus has a memory device in which a plurality of data characteristic of the plastics material preforms is stored. For example, reference images of plastics material preforms can be stored in this memory device, for example of proper plastics material preforms. This memory device can be an internal memory device or a cloud, for example.

Preferably, a comparison device is provided which compares this data with data recorded by the at least one inspection device. In this manner, it is possible to determine whether the respective plastics material preforms are correct, for example, as part of an image evaluation. Artificial intelligence (AI) can preferably be used for the purpose of this evaluation or comparison.

In a preferred embodiment, the transport device has a removal device that is suitable and intended for picking up groups of produced plastics material preforms from the production device.

In a further preferred embodiment, the transport device has a movable carrier that is configured to hold a plurality of plastics material preforms.

Preferably, the first region of the plastics material preforms is a mouth region of the plastics material preforms. Preferably, the mouth region has a thread and in particular an external thread.

Preferably, the apparatus has a forming device for forming the plastics material preforms into plastic material containers and, in particular, plastic material bottles. This forming device can preferably be an arrangement described in more detail below for the production of plastics material containers.

In a further preferred embodiment, the forming device has a movable and in particular a rotatable carrier, wherein the forming stations are preferably arranged on this carrier. Particularly preferably, each forming station has a blow mold and preferably each of these forming stations has a rod-like body and in particular a so-called stretching rod, which can be inserted into these plastics material preforms for stretching the plastics material preforms.

In the further preferred embodiments, each forming station has an application device for applying a gaseous medium to the plastics material preforms and preferably also has a valve arrangement such as a valve block. This valve arrangement preferably has a plurality of valves that control the pressure application of the plastics material preforms. The application device preferably has a so-called blowing nozzle, which can be placed against a mouth of the plastics material preforms.

Particularly preferably, the production device is an injection molding machine. Particularly preferably, this injection molding machine has at least 10, preferably at least 20 and particularly preferably at least 30 production units.

Particularly preferably, the production device and in particular the injection molding machine has a maximum of 200, preferably a maximum of 180, preferably a maximum of 160 production units.

It is possible that the production units are arranged on a common carrier. Preferably, each of these production units is suitable and intended for producing exactly one plastics material preform. Preferably, the production units are in each case mold tools.

In a further preferred embodiment, the production units in each case have marking devices that are suitable and intended for applying markings to the plastics material preforms to be produced, wherein these markings are preferably characteristic at least of the particular production unit.

Preferably, a clear position of the plastics material preforms in the removal device or in the take-off/picker makes it possible to assign the plastics material preform to the cavity of the tool or the production unit.

Preferably, it is possible to forward an evaluation and/or transfer of the recognized cavities or production units or mold tools to the control device of the production device, in order to recognize trends/evaluations and preferably also to visualize them.

The image recording device of the first inspection device can be pivoted (into place) in order to record the image(s). It would also be possible that the plastics material preforms are transported next to and/or above the first inspection device and/or a second inspection device described in more detail below.

In a further advantageous embodiment, the apparatus has an assignment device that is suitable and intended for assigning to each inspected plastics material preform the forming station that will form this plastics material preform into a plastics material container.

Particularly preferably, the apparatus also has a control device for controlling the forming device, wherein this control device is suitable and intended for controlling each forming station separately and/or independently of other forming stations. Particularly preferably, this control device is suitable and intended for controlling the forming stations also as a function of a value that is obtained by inspecting the plastics material preforms with the first inspection device and/or that is characteristic of an inspection result of an inspection of the plastics material preforms with the first inspection device.

Preferably, the first inspection device is suitable and intended for inspecting several plastics material preforms and/or for outputting at least one value for each of the inspected plastics material preforms, which value is characteristic of this individual plastics material preform.

For example, the inspection device can record an image of a plurality of plastics material preforms and from this image at least one value can be output for each individual one of this plurality of plastics material preforms, which is characteristic of this particular plastics material preform and/or the inspection of this particular plastics material preform.

In a further preferred embodiment, the inspection device has an evaluation device that is suitable and intended for evaluating the images recorded by the inspection device. Particularly preferably, this evaluation device is suitable and intended for individualizing individual plastics material preforms from an image recorded by the image recording device, which shows a plurality of plastics material preforms, and preferably also for determining values characteristic of these plastics material preforms.

In a further familiar embodiment, the transport device is suitable and intended for transporting the plastics material preforms individually from the production device and, in particular, transporting them to the forming device. Individually is understood to mean that the plastics material preforms are transported individually and therefore each individual plastics material preform can be customized. For example, this transport device can have at least one or preferably several transport wheels and/or transport chains. Preferably, the transport device is configured in such a way that a predefined sequence of the transported plastics material preforms is maintained.

However, individual transport is also possible if the plastics material preforms are transported on a common carrier, but the individual plastics material preforms have a defined position in relation to one another, which is given for example by the shape of the carrier, for example if the carrier has a plurality of receiving means for holding individual plastics material preforms. Preferably, the transport device has at least one transport unit that transports the plastics material preforms in a single row. Preferably, the transport device has at least one transport unit that transports the plastics material preforms as an array, such as in particular the above-mentioned transport carrier that receives a plurality of plastics material preforms.

Non-individual transport occurs, for example, if a plurality of plastics material preforms are placed in a common receiving container, in which they are positioned arbitrarily relative to one another.

Due to this individualization, an assignment of individual inspected plastics material preforms to forming stations or production units is possible.

In a further advantageous embodiment, the transport device has a carrier that is suitable for receiving a plurality of plastics material preforms.

Preferably, the transport device has a carrier that is suitable for the receptacle of a plurality of plastics material preforms, each with the same orientation. Particularly preferably, the plastics material preforms are transported by the carrier in an alignment parallel to one another.

Particularly preferably, this carrier can be transported in two independent directions, in particular in two mutually perpendicular directions, as part of the transport device.

Preferably, the transport device has a removal device that is suitable and intended for picking up the plastics material preforms-preferably from the cooling device. Preferably, this removal device is also suitable and intended for picking up individual plastics material preforms and supplying them to a subsequent transport path. Furthermore, this removal device is preferably also suitable and intended for picking up individual plastics material preforms and/or discharging them from the transport path.

Preferably, the second inspection device is suitable and intended to inspect the cooled plastics material preforms and/or to inspect the plastics material preforms during and/or after their cooling.

In a further preferred embodiment, the apparatus has at least one illumination device that is suitable and intended for illuminating plastics material preforms inspected by the first inspection device and/or by the second inspection device. It is also possible that the plastics material preforms are positioned next to and/or below and/or above this illumination device, in order to inspect the plastics material preforms.

Preferably, this second inspection device is suitable and intended for inspecting a main body of the plastics material preforms.

In a further preferred embodiment, the apparatus has a further assignment device, which is suitable for assigning to each plastics material preform inspected by the second inspection device the forming station that will form this plastics material preform into a plastics material container.

Preferably, the above-mentioned control device for controlling the production device is suitable and intended for controlling the production units using at least one value that is characteristic of an inspection result of the inspection of the plastics material preforms with the second inspection device.

Particularly preferably, the above-mentioned control device for controlling the forming device is suitable and intended for controlling the forming stations also as a function of a value that is obtained by inspecting the plastics material preforms with the second inspection device and/or that is characteristic of an inspection result of an inspection of the plastics material preforms with the second inspection device.

Preferably, the second inspection device is suitable and intended for inspecting several plastics material preforms and/or for outputting at least one value for each of the inspected plastics material preforms, which value is characteristic of this individual plastics material preform.

For example, the second inspection device can record an image of a plurality of plastics material preforms and from this image at least one value can be output for each individual one of this plurality of plastics material preforms, which value is characteristic of this particular plastics material preform and/or the inspection of this particular plastics material preform.

In a further preferred embodiment, the second inspection device has an evaluation device that is suitable and intended for evaluating the images recorded by the inspection device. Particularly preferably, this evaluation device is suitable and intended for individualizing individual plastics material preforms from an image recorded by the image recording device, which image shows a plurality of plastics material preforms.

In this embodiment, it is provided that at least two inspection devices are present, which inspect the plastics material preforms. In this way, a relationship can also be established between the state of the plastics material preforms before and after cooling the plastics material preforms.

It is also possible that the two inspection devices inspect different regions of the plastics material preform(s). Preferably, the first inspection device inspects a mouth region of the plastics material preforms, while the second inspection device inspects a main body of the plastics material preforms. Preferably, the mouth region of the plastics material preforms is a region of the plastics material preforms that is not formed by the forming device, whereas the main body of the plastics material preforms is a region of the plastics material preforms that is formed and, in particular, expanded by the forming device.

In a further advantageous embodiment, at least one inspection device and preferably the first and second inspection device are suitable and intended for detecting at least one and preferably a plurality of values that are characteristic of physical properties of the plastics material preforms.

Particularly preferably, these properties are selected from a group of properties including a geometry of the plastics material preforms, a cross-section of the plastics material preforms, a length of the plastics material preforms, a color of the plastics material preforms, a transparency of the plastics material preforms, a moisture value of the plastics material preforms, an IV value (intrinsic viscosity) of the plastics material preforms, a temperature of the plastics material preforms, damage to the plastics material preforms and the like.

In a further preferred embodiment, at least one inspection device is suitable and intended for inspecting the plastics material preforms during their movement. Preferably, both the first and the second inspection device are suitable and intended for inspecting the plastics material preforms during their movement.

In a further advantageous embodiment, the apparatus has a heating device for heating the plastics material preforms produced by the production device. This heating device can be, for example, an infrared or microwave oven.

Particularly preferably, this heating device is arranged between the cooling device and the forming device. Particularly preferably, the heating device also has a transport device that transports the plastics material preforms individually. Furthermore, this heating device preferably also has a rotating device for rotating the plastics material preforms with respect to their axis during heating.

In a further advantageous embodiment, the apparatus has a discharge device that is suitable and intended for ejecting or discharging individual plastics material preforms from the transport path of the plastics material preforms between the production device and the forming device. Discharge is understood to mean that such plastics material preforms are no longer supplied to the forming process.

Particularly preferably, this discharge device is arranged downstream of the second inspection device and/or upstream of the forming device. Particularly preferably, this discharge device is suitable and intended for discharging individual plastics material preforms in response to an inspection result of at least one of the inspection devices. However, it would also be conceivable that a third inspection device is provided and that the discharge device discharges individual plastics material preforms taking into account an inspection result from this third inspection device.

In a further advantageous embodiment, the apparatus has a gap-closing device that closes gaps created by the discharge of individual plastics material preforms. This gap-closing device can have a buffer that fills existing gaps.

In a further advantageous embodiment, the apparatus, and in particular the transport device, has a turning device that changes the alignment of transported plastics material preforms.

Preferably, the apparatus has a carrier on which a plurality of plastics material preforms can be arranged after their production, and the turning device is suitable and intended for turning the carrier with the plastics material preforms arranged thereon.

Preferably, this turning device is suitable and intended for turning the plastics material preforms by a predefined angle, preferably by 90°. Preferably, the turning device is suitable and intended for turning the plastics material preforms from a horizontal alignment (i.e., an alignment in which the longitudinal directions of the plastics material preforms run horizontally) to a perpendicular alignment (i.e., an alignment in which the longitudinal directions of the plastics material preforms are aligned perpendicularly or vertically).

Preferably, the first inspection device is suitable and intended for recording an image of the plastics material preforms in their horizontal alignment.

Preferably, the second inspection device is suitable and intended for recording an image of the plastics material preforms in their perpendicular alignment.

In a further advantageous embodiment, the apparatus has at least one vacuum holding apparatus that is suitable and intended for holding individual plastics material preforms on holding bodies using negative pressure.

Due to this vacuum holding device, it is possible to detach individual plastics material preforms from their carriers.

Particularly preferably, a vacuum device of this kind is assigned to each plastics material preform. Individual plastics material preforms can therefore be detached from their holding devices by removing the vacuum. Preferably, the vacuum device is suitable and intended for detaching individual but in particular specific plastics material preforms from their holders using at least one inspection result of an inspection device.

Preferably, this vacuum device is a component of the discharge device.

In a further advantageous embodiment, the apparatus has a third inspection device for inspecting the plastics material preforms, wherein this third inspection device is preferably arranged downstream of the second inspection device.

This third inspection device is in particular suitable and intended for detecting impurities in the plastics material preforms produced (for example, so-called black specs).

The present invention is further directed to an arrangement for producing plastics material containers having an apparatus of the type described above and a forming device which forms the plastics material preforms produced into plastics material containers, wherein further the transport device is suitable and intended for transporting the plastics material preforms from the production device to the forming device.

The forming device has already been described in detail above.

The present invention is further directed to a method for producing plastics material preforms, wherein a production device produces plastics material preforms and wherein the production device has a plurality of production units which each produce the plastics material preforms, and wherein a transport device transports the plastics material preforms produced by the production device. Furthermore, a control device controls the production device and in particular the production units.

According to the invention, a first inspection device is provided which inspects at least one area of the plastics material preforms produced by the production device, wherein the inspection device outputs at least one value which is characteristic of a physical property of the plastics material preforms and wherein the apparatus has an assignment device which assigns to each inspected plastics material preform the production unit which has produced this plastics material preform and wherein the control device controls the production device and in particular the production units as a function of this value.

Preferably, this first inspection device takes (at least) one spatially resolved image of a plurality and in particular of each of the transported plastics material preforms (wherein preferably a single image shows a plurality of plastics material preforms). With a preferred method, the plastics material preforms recorded by the image recording device are at least partially detected individually. Preferably, all plastics material preforms are detected individually.

Preferably, the first inspection device outputs a plurality of values, wherein each of these values is characteristic of exactly one plastics material preform received by the inspection device.

Preferably, the first inspection device records an image of the plastics material preforms during a movement of the plastics material preforms.

In a further preferred method, at least one and preferably a plurality of plastics material preforms is assigned to the production unit that has produced this plastics material preform.

In a further preferred method, at least one plastics material preform inspected by the first inspection device, preferably a plurality of plastics material preforms inspected by the first inspection device and preferably all plastics material preforms inspected by the first inspection device are each assigned the forming station which will form this plastics material preform into a plastics material container.

Preferably, the transport of the plastics material preforms is carried out individually, at least in portions.

Particularly preferably, the plastics material preforms are transported at least in portions by a receiving carrier that is suitable for receiving a plurality of the plastics material preforms.

In a further preferred method, the plastics material preforms are reheated after their cooling. In particular, the main bodies of the plastics material preforms are heated so that they can be formed into plastics material bottles.

### BRIEF DESCRIPTION OF THE DRAWINGS

Further advantages and embodiments can be seen in the accompanying drawings.

In the drawings:

FIG. 1 shows a roughly schematic representation of an apparatus according to the invention;

FIG. 2 shows a representation of a production device for producing plastics material preforms in a first view; and

FIG. 3 shows a further view of the production device shown in FIG. 2;

FIG. 4 shows a representation for illustrating the method according to the invention.

### DETAILED DESCRIPTION OF THE INVENTION

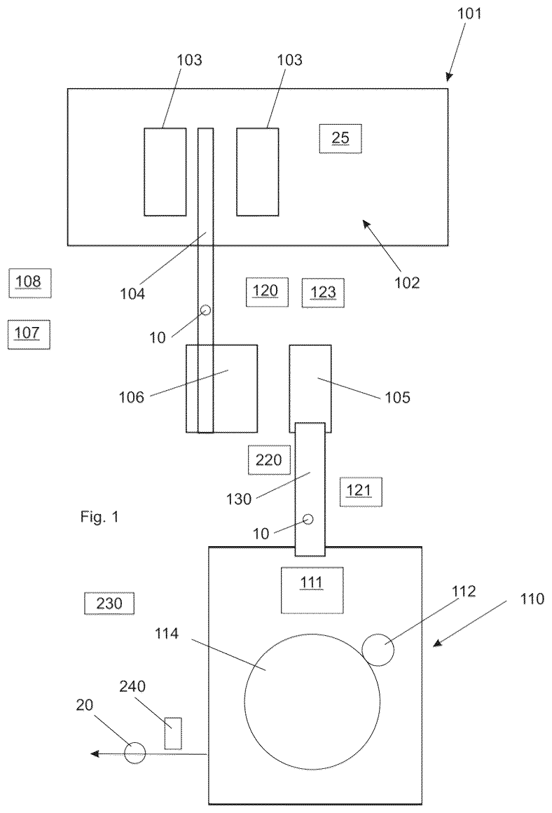

FIG. 1 shows a roughly schematic representation of an apparatus 101 for producing plastics material containers. This apparatus 101 has a production device 102 that produces plastics material preforms 10. Preferably, this production device 102 is an injection molding machine. This production device 102 has a plurality of production units 103 and, in particular, mold tools, each of which is suitable and intended for producing individual plastics material preforms 10.

The reference sign 25 identifies a control device for controlling the production device and, in particular, also the individual production units. Preferably, this control device is a regulating device.

The reference sign 104 schematically designates a removal device that removes the injection-molded plastics material preforms 10 from the production units 102. This removal device can be part of the above-mentioned control device.

The reference sign 106 designates a cooling device, in particular in the form of a post-cooling unit, which cools the plastics material preforms 10 produced. Preferably, the plastics material preforms are inserted into this cooling device 106 and/or supplied to the cooling device directly after their production.

An inspection device, and in particular a first inspection device 120, is arranged along the transport path of the transport device 104, which inspects the plastics material preforms. This first inspection device 120 is in particular suitable and intended to inspect each individual plastics material preform or to detect a property characteristic of this plastics material preform.

As mentioned above, the inspection device has, in particular, an image recording device which is suitable and intended for the recording of images. The reference sign 123 identifies an evaluation device which evaluates the images recorded by the image recording device.

This inspection device and/or the evaluation device preferably outputs at least one value W1 that is characteristic of the inspected plastics material preforms. Preferably, the inspection device outputs such a value W1 for each inspected plastics material preform.

The reference sign 108 indicates an assignment device which assigns a production unit 103 which has produced this plastics material preform to each plastics material preform 10 which has been inspected. The control device is advantageously suitable and intended for controlling the individual production units also as a function of the measured or output values of the individual plastics material preforms.

The reference sign 105 designates a transport device and, in particular, a handling unit that picks up the plastics material preforms 10 from the transport device 104.

Additionally or alternatively, the assignment device 108 is also capable of assigning to each plastics material preform the forming station 112 that will form that plastics material preform into a plastics material container.

Preferably, therefore, the first inspection device is arranged between the production device and/or the individual production units and the cooling device 106 and/or the transport device 105.

The reference sign 121 identifies a second inspection device which detects at least one value which is characteristic of the respective inspected plastics material preform. Here as well, it can preferably be a value that is selected from a group of values that includes a geometry of the plastics material preforms, a color of the plastics material preforms, a moisture content of the plastics material preforms, an IV value of the plastics material preform, a temperature of the plastics material preform or the like.

Preferably, these values are made available to a higher-level control system in order to control parameters of the overall apparatus.

The reference sign 220 indicates a further inspection device which is used to inspect the plastics material preforms.

Furthermore, a discharge device can be provided, which (in particular depending on the characteristic values mentioned) has the effect that individual plastics material preforms are not transferred to the forming device 112. The reference sign 230 identifies a control device for controlling the forming device. This control device can preferably control and preferably regulate the forming device taking into account the results of the individual inspections of the plastics material preforms and/or taking into account the individual values output. The reference sign 240 identifies a further optional inspection device, which is particularly suitable and intended for inspecting the manufactured containers.

Furthermore, a gap-closing device (not shown) can be provided, which closes any gaps created by the discharge of individual plastics material preforms.

The reference sign 110 designates in its entirety a forming device that forms the plastics material preforms into plastics material containers 20.

A heating device 111 is preferably provided first, which heats the plastics material preforms to a temperature that is suitable for forming and, in particular, expanding them into the plastics material containers 20.

The forming device 110 preferably has a rotatable carrier 114, on which a plurality of forming stations 112 are arranged. These forming stations are preferably controllable independently of one another.

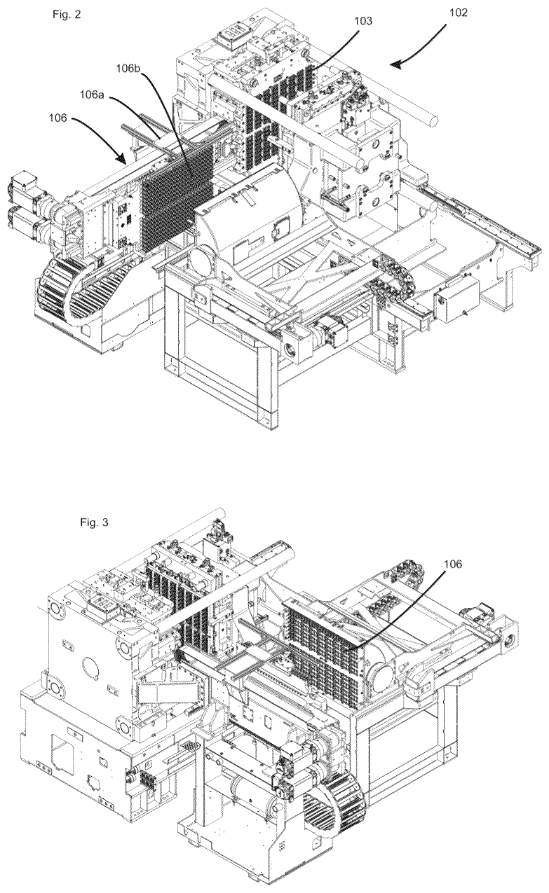

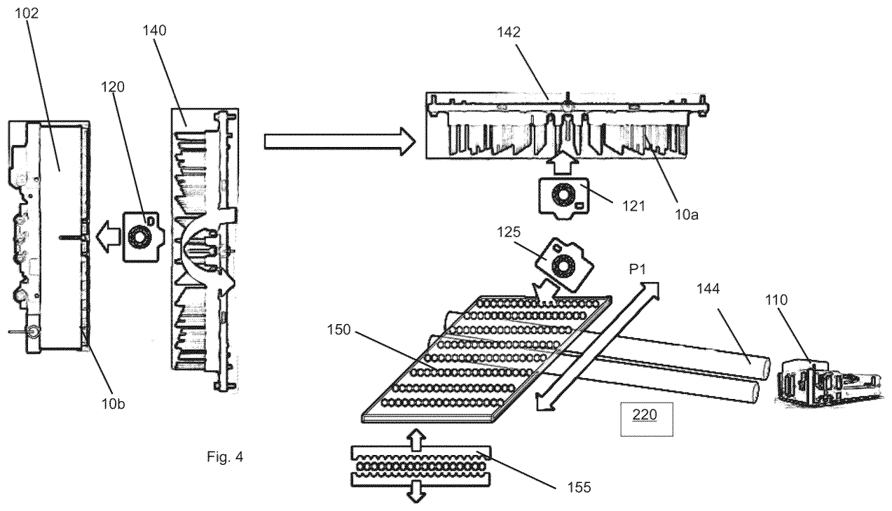

FIG. 2 and FIG. 3 show a first view of a production device 102 for producing the plastics material preforms. The reference sign 103 designates a plurality of production units, which in each case produce individual plastics material preforms.

The reference sign 106 designates a cooling device for cooling the plastics material preforms. The reference sign 106a designates a removal device for removing the plastics material preforms after the production process. The reference sign 106b indicates holding elements for the individual plastics material preforms.

FIG. 4 shows a representation for illustrating the apparatus according to the invention and the method according to the invention.

The production device 102 is provided, which has a plurality of production units (not shown in detail), which in each case produce the plastics material preforms. One can see the mouths 10b of the individual plastics material preforms.

The reference sign 120 designates the first inspection device, which here in particular records an image of the mouths 10b, wherein the individual mouths and thus the individual plastics material preforms can be individualized.

The reference sign 140 designates a turning device that turns the carrier with the plastics material preforms arranged thereon, in this case by 90°. In addition, the plastics material preform is cooled in this region by a cooling device (not shown here).

The turned carrier 142 is transported with the plastics material preforms arranged thereon and a second inspection device 121 records at least one image of the plastics material preforms, more precisely, now of the main bodies 10a of the plastics material preforms.

The reference sign 125 designates a third inspection device, which also inspects the plastics material preforms arranged in a carrier. Preferably, an inspection for material defects such as so-called black specs takes place here.

A vacuum holding device (not shown) is provided in the region of the carrier 142 and ensures that each individual plastics material preform is held on its own carrier. In this way, defective plastics material preforms can be separated from correct plastics material preforms.

In the embodiment shown in FIG. 4, defective plastics material preforms are initially still held by their (vacuum) grippers, while correct plastics material preforms are dropped onto a further transport unit 150.

From this further transport unit in the form of a carrier 150, the preforms can in turn be dropped onto a further transport unit 144, which in this case comprises two rollers arranged parallel to one another, between which the plastics material preforms 10 are guided. For this purpose, the carrier 150 with the individual plastics material preforms can be displaced along the arrow P1 relative to the further transport unit.

Strictly speaking, the carrier with the plastics material preforms is moved laterally over the transport unit 144. For this purpose, gaps 155 can open on the carrier, as shown at the bottom of FIG. 4, and the plastics material preforms can be dropped between the rollers.

The defective plastics material preforms, which are still held on the carrier 142 by vacuum grippers, can be ejected by selective control when the carrier 142 is retracted.

The applicant reserves the right to claim all features disclosed in the application documents as essential to the invention, provided that they are novel over the prior art individually or in combination. It is also pointed out that features which can be advantageous in themselves are also described in the 10 individual figures. A person skilled in the art will immediately recognize that a particular feature described in a figure can be advantageous even without the adoption of further features from this figure. Furthermore, the person skilled in the art will recognize that advantages can also result from a combination of several features shown in individual or in different figures.

1. An apparatus for producing plastics material preforms, having a production device which is configured for producing plastics material preforms, wherein the production device has a plurality of production units for producing the plastics material preforms, and having a transport device which is configured for transporting the plastics material preforms produced by the production device, wherein the apparatus has a control device for controlling the production device,
wherein
the apparatus has a first inspection device which is configured for inspecting at least one area of the plastics material preforms produced by the production device, wherein the inspection device is configured for outputting at least one value which is characteristic of a physical property of the plastics material preforms,
wherein the apparatus has an assignment device which is configured for assigning to each inspected plastics material preform the production unit which has produced this plastics material preform, and wherein the control device is configured for controlling the production device as a function of this value.

2. The apparatus according to claim 1,
wherein
the production units each have cavities for forming the plastics material preforms and/or mold tools for forming the plastics material preforms.

3. The apparatus according to claim 1,
wherein
at least one parameter of the production device and/or the production) units can be controlled.

4. The apparatus according to claim 1,
wherein
the control device for controlling the production device is a control device which is configured for controlling the production device as a function of this at least one value.

5. The apparatus according to claim 1,
wherein
the apparatus has a cooling device configured for cooling the plastics material preforms produced by the production units.

6. The apparatus according to claim 1,
wherein
first inspection device has an image recording device which is configured for recording a spatially resolved image of a plurality of plastics material preforms.

7. The apparatus according to claim 1,
wherein
the apparatus has a second inspection device which is configured for inspecting the plastics material preforms.

8. The apparatus according to claim 7,
wherein
wherein the apparatus has an assignment device which is configured for assigning to each plastics material preform inspected by the second inspection device the production unit which has produced this plastics material preform.

9. The apparatus according to claim 1,
wherein
the apparatus has a turning device configured to change an alignment of transported plastics material preforms.

10. The apparatus according to claim 1,
wherein
the apparatus has a memory device in which a plurality of data characteristic of the plastics material preforms is stored.

11. The apparatus according to claim 1,
wherein
the apparatus has a heating device configured for heating the plastics material preforms produced by the production device.

12. The apparatus according to claim 1,
wherein
the apparatus has a discharge device that is configured for ejecting individual plastics material preforms from the transport path between the production device and the forming device.

13. An arrangement for producing plastics material containers, having an apparatus according to claim 1 and a forming device which is configured for forming the plastics material preforms produced into plastics material containers, wherein further the transport device is configured for transporting the plastics material preforms from the production device to the forming device.

14. A method for producing plastics material preforms, wherein a production device produces plastics material preforms, wherein the production device has a plurality of production units which produce the plastics material preforms and wherein a transport device transports the plastics material preforms produced by the production device and a control device controls the production device,
wherein
a first inspection device is provided which inspects at least one area of the plastics material preforms produced by the production device, wherein the inspection device outputs at least one value which is characteristic of a physical property of the plastics material preforms, wherein the device has an assignment device which assigns to each inspected plastics material preform the production unit which has produced this plastics material preform and wherein the control device controls the production device as a function of this value.
